(19) United States
(12) Patent Application Publication
(10) Pub. No.: US 2007/0082213 A1
(43) Pub. Date: Apr. 12, 2007

(54) Aluminum Oxide micro dust / paint coated wood

(76) Inventor: James William Cerny, St. Marys, GA (US)

Correspondence Address: JAMES WILLIAM CERNY, 108 F INDUSTRIAL DRIVE, ST. MARYS, GA, 31558, US

(21) Appl. No.: 11/526,832

(22) Filed: Sep. 26, 2006

Related U.S. Application Data
(60) Provisional application No. 60/720,354, filed on Sep. 26, 2005.

(51) Int. Cl. B05D 1/12; B32B 21/04

(52) U.S. Cl. 428/537.1; 427/180

(57) ABSTRACT

This invention provides a Water Resistant coating to all types and forms of wood products. The Aluminum Oxide Micro Dust provides a water repellant matrix that resists water. The composition of the coating provides increased abrasive wear properties, that extend the life of the coating and function of the coating. The coating enhances the Structural Strength, Sound Deadening and Insect/Disease resistance properties of wood.

### 35 U.S.C 112 SPECIFICATION

Brown Fused Aluminum Oxide is used in the coating removal Industry as a non ferrous abrasive blasting media. The chemical properties of Fused Aluminum Oxide, when pulverized to a micro dust does not readily mix with water. The use of an adhesive to assist the micro dust to adhere to wood, allows the wood to take on these water repellent properties, as well a provide an abrasive enhanced surface.

The process utilizes a unique micro dust matrix of aluminum oxide particles that bond together with a two part epoxy paint to form a water repellent membrane and abrasive enhanced coating.

This process includes any wood that has been air dried, oven dried Or pressure treated.

It is applicable to all types and forms of wood products. The adhesive is not limited to paint but covers any and all Adhesives that could be used to assist the micro dust to adhering to the wood surface.

General Process:

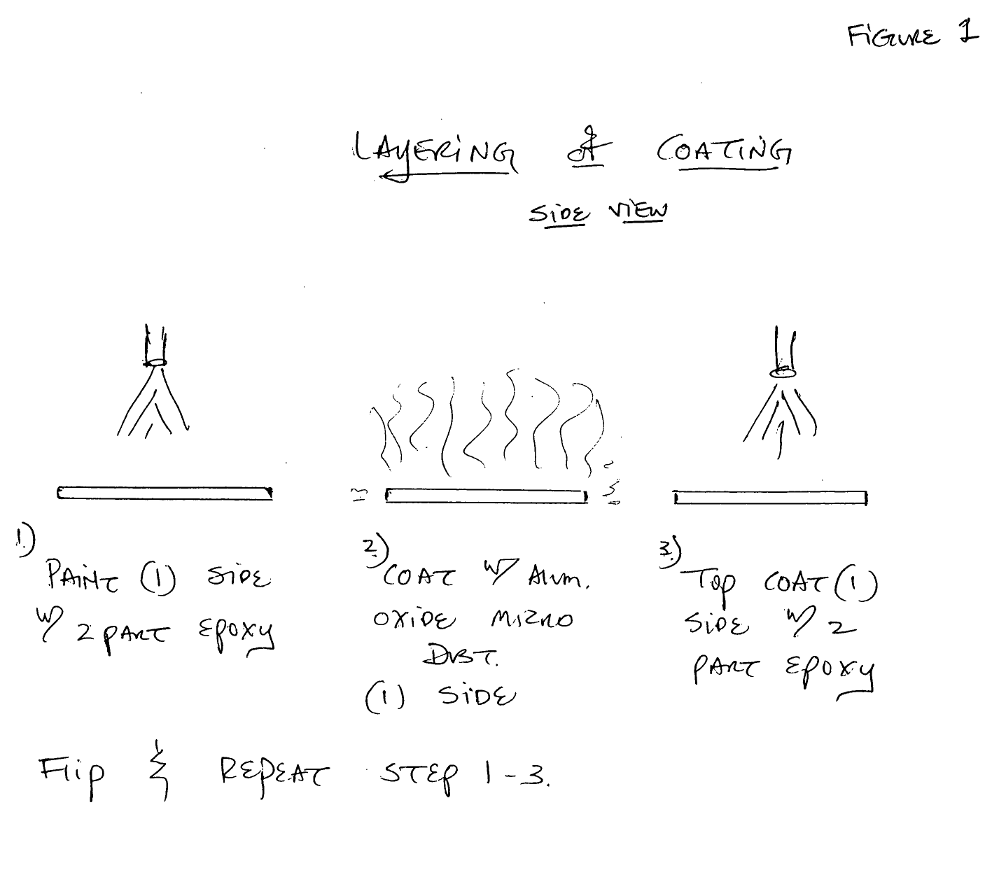

Utilizing wood products that have a smooth to semi smooth finish, and dry to indoor atmospheric conditions. A coating of paint or similar liquid adhesive binder is applied to the wood surface. Dependent upon the size of the wood product being coated, it may be sprayed, rolled or dipped. FIG. 1 It is imperative that all surfaces of the wood are coated evenly. The adhesive or binder must be sufficient in thickness to provide a base for the coating. The coating, Micro Dust Aluminum Oxide, is then distributed evenly to all the wetted surfaces. The newly applied coating is then allowed to dry forming a bond between the adhesive and the Micro Dust. This bond provides a water resistant membrane around the wood. The drying time is dependent upon the type of adhesive or paint that is used and the atmospheric conditions. When the coated has dried the excess Micro dust is allowed to fall away from the Dried Coated Surface. A second coat/sealing coat is then uniformly applied and dries. FIG. 1.

Specific Process for Models: ½ Plywood—Pine, 12″×12″
2×4×12″ Pine Board

Wood was purchased from a Standard Lumber Yard. The Plywood was utility grade 4×8×½″ thick and 2″×4″×8′ interior grade Board. A 12″×12″ square was cut from the Plywood sheet and a 12″ long section was cut from the 8′ board.

A two part epoxy paint was mixed together parts A & B according to the manufacture's recommendations. Using an airless paint spray gun, 6 mils of paint were evenly applied to one side and the edges of each sample. FIG. 1. A uniform Micro Dust-Aluminum Oxide was then evenly distributed over the painted surfaces. FIG. 1. Both products were then allowed to dry for 24 hours. The samples were then turned and the paint and dust applied to the other side. Previously, coated surfaces were overlapped with the newly painted/coated side. Both products were again allowed to dry for 24 hours. A second coat of the two part epoxy, 6 mils was applied to one side and allowed to dry for 24 hours. FIG. 1. The samples were then turned over and the second coat was applied to the remaining unpainted Aluminum Oxide coating. The finish product was available for use 24 hours after the final coating was applied.

Testing of Coating:

1 sample of wood uncoated—½ plywood and 2×6×12 pine board

1 sample of wood coated with 1 coat of two part epoxy paint @ 6 mils—½″ plywood and 2×6×12″ pine board

1 sample of wood coated with 2 coats of two part epoxy paint @ 6 mils—½″ plywood and 2×6×12″ pine board

1 sample of wood coated with 1 coat of two part epoxy paint, 1 coat of Aluminum Oxide Micro Dust, 1 coat of two part epoxy paint @ 6 mils—½ plywood and 2″×6″×12″ pine board

All of the samples were cut to the same exact dimensions.

All of the samples were weighed and recorded before the coatings were applied.

All of the samples were weighed and recorded after the coating were applied.

Four sets of samples were made and recorded—two for record and two for testing.

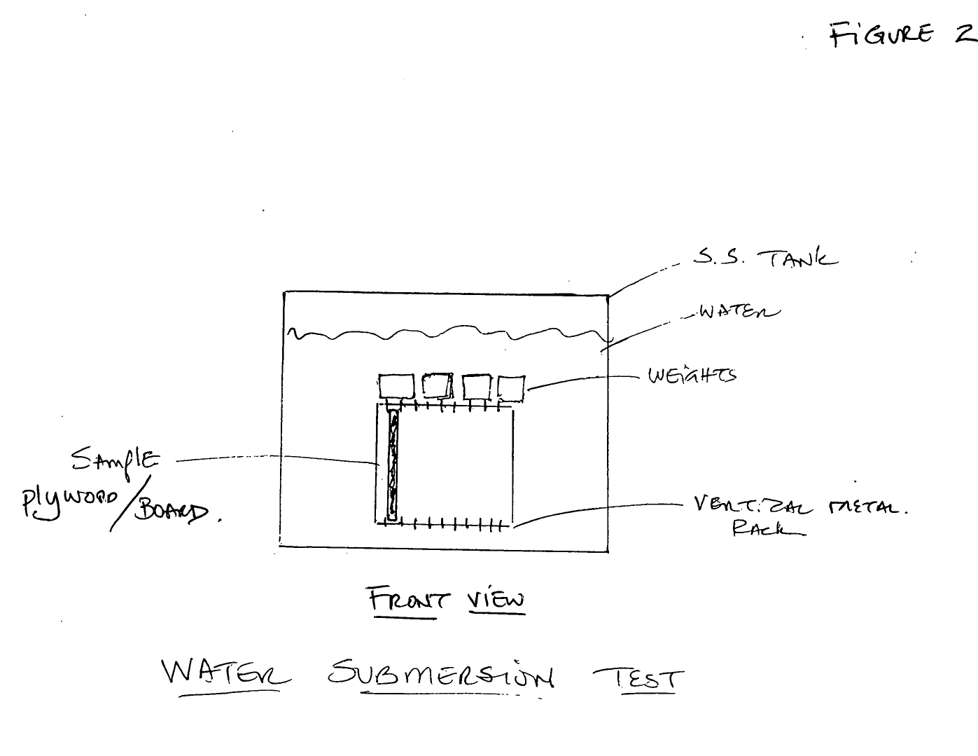

To conduct the Water Resistant Testing, the samples were submerged in a stainless steel tank of water for 24 hours. FIG. 2. Each sample was placed in a rack vertically to insure that the sides and tops did not touch—they were then weighed down to the bottom of the 42″ tank. FIG. 2.

After 24 hours the samples were removed, weighed and recorded. The samples were then stored inside a building for 24 hours and then weighed and recorded.

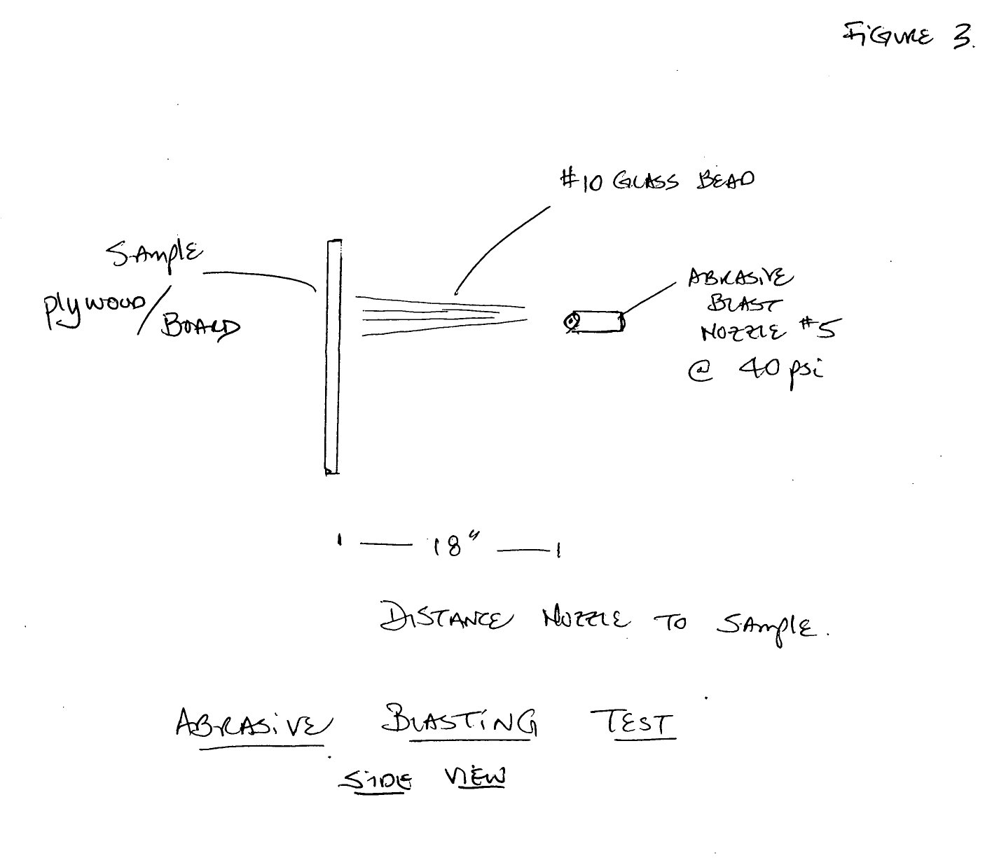

To conduct the Abrasive Resistant Testing, the samples were Blasted with #10 Glass Bead, in a Hand Blast Cabinet—using a Blasting pressure of 40 psi with a number 5 nozzle. FIG. 3. The samples were blasting vertically and the nozzle was located 18 inches away from the samples.

Each item was blasted under the same operating conditions. A clock with a second hand recorded the duration of blast. The timing stopped when a uniform blast pattern was reached for each sample.

Water Resistant Testing Results:

| Description | Tag # | Dry Wgt | Wet Wgt | % Water |
|---|---|---|---|---|
| Plywood Uncoated | 1 | 1.6 # | | |
| Plywood Uncoated | 2 | 1.8 # | 2.4 # | 25% |
| Plywood Coated (1) | 7 | 2.0 # | | |
| epoxy | | | | |
| Plywood Coated (1) | 5 | 2.0 # | 2.4 # | 17% |
| Epoxy | | | | |
| Plywood Coated (2) | 9 | 2.2 # | | |
| Epoxy | | | | |
| Plywood Coated (2) | 10 | 2.2 # | 2.4 # | 8% |
| Epoxy | | | | |
| Plywood Coated (2) | 23 | 2.4 # | | |
| Epoxy | | | | |
| (1) ALOX | | | | |
| Plywood Coated (2) | 21 | 2.4 # | 2.4 # | 0% |
| Epoxy | | | | |
| (1) ALOX | | | | |
| 2 × 4 Uncoated | 4 | 1.2 # | | |
| 2 × 4 Uncoated | 2 | 1.2 # | 1.6 # | 20% |
| 2 × 4 Coated (1) | 8 | 1.6 # | | |
| Epoxy | | | | |
| 2 × 4 Coated (1) | 6 | 1.6 # | 1.8 # | 13% |
| Epoxy | | | | |
| 2 × 4 Coated (2) | 11 | 1.6 # | | |
| Epoxy | | | | |
| 2 × 4 Coated (2) | 9 | 1.6 # | 1.8 # | 13% |
| Epoxy | | | | |
| 2 × 4 Coated (2) | 23 | 1.8 # | | |
| Epoxy | | | | |
| (1) ALOX | | | | |
| 2 × 4 Coated (2) | 21 | 1.8 # | 1.8 # | 0% |
| Epoxy | | | | |
| (1) ALOX | | | | |

Abrasive Resistant Testing Results:

| Description | Tag # | Seconds |
|---|---|---|
| Plywood Coated (1) epoxy | 7 | 15 |
| Plywood Coated (2) epoxy | 9 | 25 |
| Plywood Coated (2) epoxy | 23 | 55 |
| 2 × 4 Coated (1) epoxy | 8 | 15 |
| 2 × 4 Coated (2) epoxy | 11 | 20 |
| 2 × 4 Coated (2) epoxy | 23 | 50 |
| (1) ALOX | | |

### DRAWING —SECTION 113

Attached—Layering of coating sketch—FIG. 1

Water Submersion Test—FIG. 2

Abrasive Blasting Test—FIG. 3

### MODEL/SPECIMEN—SECTION 114

½ pound of Aluminum Oxide Micro Dust.

One set of Samples—Dry/with Abrasive Blast Pattern

One Set of Samples Submersed & Dried

Technical Data Sheets—Two part epoxy paint.

Technical Data Sheets—Brown Fused Aluminum Oxide.

Georgia Department of Natural Resources Letter—stating the use of Aluminum Oxide dust in a painted product.

1. Water Resistant Enhanced Properties
The 24 hour submersion test was an extreme testing for this coating. This coating is not intended for submersion purposes, however the test data proved that the Coating with the Aluminum Oxide Micro Dust did not accept or retain water. We chose plywood because it is one of the most difficult wood products to protect.

2. Abrasive Resistant Enhanced Properties
The direct abrasive blasting test was also an extreme testing for this coating. This coating is not intended for direct blasting purposes, however the test data proved that the Coating with the Aluminum Oxide Micro Dust did provide protection against abrasion.
Secondary Indirect Attributes:
Structurally Enhanced Properties
Sound Deadening Enhanced Properties
Insect/Disease Resistant Enhanced Properties
